(19) United States
(12) Patent Application Publication
(10) Pub. No.: US 2018/0370122 A1
(43) Pub. Date: Dec. 27, 2018

(54) Colour 3D Printing Apparatus and a Corresponding Colour 3D Printing Method

(71) Applicant: Mcor Technologies Limited, Dunleer, Co. Louth (IE)

(72) Inventors: Fintan MACCORMACK, Ardee (IE); Conor MACCORMACK, Ardee (IE)

(21) Appl. No.: 16/065,712

(22) PCT Filed: Dec. 22, 2016
(86) PCT No.: PCT/EP2016/082501

§ 371 Date: Jun. 22, 2018

(30) Foreign Application Priority Data
Dec. 23, 2015 (GB) 1522717.6

(51) Int. Cl. B29C 64/118; B29C 64/393; B29C 64/205

(52) U.S. Cl. CPC B29C 64/118; B33Y 30/00; B29C 64/205; B29C 64/393

(57) ABSTRACT

According to the disclosure there is provided a printing apparatus for 3-D printing an object. The 3D object comprises a layered object. The apparatus has a build module, having a build platform, an application head, and a print module. The application head forming an object layer and the print module including at least one printhead for applying colour to the layer of the build object. A method of manufacturing a 3D object comprising a plurality of layers is also provided.

### CROSS-REFERENCE TO RELATED APPLICATIONS

This application is a U.S. National Stage of International Patent Application No. PCT/EP2016/082501 filed on Dec. 22, 2016, by Fintan MacCormack, et al. entitled, “Colour 3D Printing Apparatus and a Corresponding Colour 3D Printing Method”, which claims priority to U.K. Patent Application No. 1522717.6 filed Dec. 23, 2015, by Fintan MacCormack, et al. entitled, “Colour 3D Printing Apparatus and a Corresponding Colour 3D Printing Method”, both of which are incorporated by reference herein as if reproduced in their entirety.

### FIELD OF THE DISCLOSURE

The present application relates to colour 3-dimensional (3D) printing and a corresponding 3D printing method.

### BACKGROUND OF THE INVENTION

Rapid prototyping is defined as computer-controlled additive fabrication, in that an object can be fabricated by the addition of material rather than conventional machining methods that rely on removal or the subtraction of material. The term “rapid” is, it will be appreciated, a relative term but one that has specific meaning within the art, in that construction of a finished three dimensional article can take from several hours to several days, depending on the method used and the size and complexity of the model. There are known methodologies that are employed within the general field of rapid prototyping for example Layered Object Manufacture (LOM) is one form of Rapid prototyping (RP) which relates to the successive layering of adhesive-coated paper, plastic, or metal laminates which are then successively glued together and cut to shape with a knife or laser cutter.

There is an interest in providing colour 3-D printed objects. In one approach a 3-D printer having a three colour chamber and a mixing chamber may be used, typically, thermoplastic raw material, fused wires, or powder with red, yellow, and blue colours can be heated and mixed according to different ratios to form different coloured printing materials, and then the fused deposition modelling (FDM) method is used for carrying out 3D printing to obtain a coloured product.

However, there are problems with 3D printing under the FDM (fused deposition modelling) in particular relating to colour printing. Current attempts include combining various colours of raw material for example beads to get a blended colour, however, this colour can't be changed easily. Further, if for example, a colour is provided onto a bead before it enters an extrusion head, there are problems controlling the pixel colour after extrusion. Therefore, with systems that are based on the fusing or extrusion of material or mixing of different colours, there are problems with blending and with providing constant colour.

There is a need for an improved printer for printing colour 3D objects. There is a need for a printer for printing colour 3D objects that addresses the above noted and other problems.

### BRIEF SUMMARY OF THE DISCLOSURE

A system and method are provided in accordance with the disclosure. Advantageous features are provided in accordance with embodiments of the disclosure.

According to a first aspect of the disclosure, an embodiment provides a printing apparatus for 3-D printing an object comprising:
a build platform;
an application head to form an object layer of the build object at the build platform; and
   a printhead located in series with the application head and configured to apply colour to the object layer;
   wherein the printhead is configured to apply colour to one surface of the object layer to produce a layer having the required colour finish.

The object is a layered object. The object is formed by forming each layer successively onto a base (for the first layer) or the preceding layers.

Each layer is printed or has colour applied, as it is formed. The colour is applied directly to the layers during the build or 3-D printing process. Embodiments of the disclosure provide for improved and accurate application of colour to the formed layer to provide an object of improved colour finish. The colour is applied as a finish and therefore is not subject to variations or other difficulty in controlling the colour, for example arising from mixing or blending or during extrusion.

In some embodiments, the system comprises a build module, which comprises the build platform and a print module comprising the application head and the printhead.

In some embodiments, the application head is operable to form the object layer. In some embodiments, the application head is operable to directly join the medium to the build object to form the object layer.

In some embodiments, the print module comprises an input opening (502) for receiving a medium, and an output opening through which the medium is applied to the object.

In some embodiments, the layer formed by the application head is optically transparent.

In some embodiments, the medium is selected and the application head is operable such that the layer as formed is optically transparent.

In a further embodiment, the bead is comprised of a material which provides an optically transparent layer when the layer is applied to the object.

In a further embodiment, the printhead is operable to print colour to one surface only of the material to provide a coloured layer of the object.

The medium or bead may be transparent. The material of the medium or bead may be rendered transparent during the 3D printing process or by treatment of the material.

The provision of an optically transparent layer and the application of colour to one surface thereof provides an overall colour effect in the object.

The need to mix colour into a layer is obviated. The properties of the transparency of the layer material and the properties of the colour as applied to a surface of the layer combine to give the overall colour effect.

The apparatus may be configured for interchangeably receiving an application head. The apparatus may comprise one of an extrusion head, a welding head, or an ultrasonic head. The system advantageously provides that a layer may be formed and added to the build object using one of different application heads. The system allows for the application head to be interchanged for forming different objects.

In one some embodiment, the colour printhead for application of colour to the layer is located downstream from the application head.

In one some embodiments, the apparatus further comprises a controller for receiving a digital print file for use in 3D printing an object. The controller further providing control to the application head and the printhead for forming and colouring the layer.

In some embodiments, the printhead is configured to vary the colour printed as required according to the digital print file from pixel to pixel.

Advantageously, the system provides for a highly accurate colour application and colour finish. The colour is controllable to the resolution of a pixel.

Advantageously, the colour is applied directly to the as formed layer or the freshly formed layer. This reduces deterioration or error in location, or wear on the colour during formation of the layer and allows for highly accurate locating of colour on the layer.

In some embodiments, the printhead applies print colour to more than one surface.

According to a further aspect of the disclosure there is provided a method of manufacturing a colour 3D object including applying a medium to a build object layer by layer including:
Providing a bead or input material to the 3D printer,
Selecting an application head,
Providing a digital print file to controller,
Forming an object layer from the input material, the object layer having a form according to the digital print file,
Printing a surface of the object layer wherein the colour may be varied as required according to the digital print file from pixel to pixel.

In some embodiments, the bead is a transparent bead or medium or a bead which is rendered optically transparent upon application to the build object to form a layer thereof or upon treatment of the build object.

In some embodiments, the method further comprises forming each layer and printing each layer in a single continuous process. Each layer is formed by the application head. Each layer is printed by the printhead. The application head and printhead are arranged in series.

The object is a layered object. The digital print file provides details for each layer of the object including the form—i.e. how each layer is rendered or formed; physical form; shape; and layout of each layer is provided to the 3-D printer. Similarly, the digital print file provides details of which colour is to be applied to the layer and at which location.

The bead may be a transparent bead, i.e. of an optically transparent material. Alternatively, the material may be rendered transparent by the application process or by another treatment.

In some embodiments, the final optical properties of the object layer are provided by selection of the transparent bead and the application head to form the layer. In some embodiments, the application head is configured to control the optical properties of the layer. In some embodiments, the application head is configured to control the optical properties of the layer by one of application, pressure, or temperature.

In a further embodiment, the bead is comprised of a material which provides an optically transparent layer when the layer is formed or applied to the object.

In a further embodiment, the printhead is operable to print colour to one surface only of the material to provide a coloured layer of the object.

In an alternative embodiment, colour may be applied to one or more surfaces of a layer.

Advantageously, based on the synergy of the optically transparent layer and the application of colour to one surface of the layer, the required optical properties of the layer including the colour thereof are achieved. The colour of each layer is based on the interaction of both the properties of the transparency of the layer and of the colour applied to a surface of the layer. In the case that the colour is applied to a surface that is not an exposed or external surface, the colour is visible by virtue of the properties of transparency of the layer.

According to a second aspect, the present disclosure provides a printing apparatus for 3-D printing an object comprising:
a build module, having a build platform, and
a print module comprising:
   at least one printhead for printing directly onto the medium as it passes through the print module; and
   an application head operable to join the printed medium to the build object.

In some embodiments, the application head comprises an ultrasonic head operable to directly weld the medium to the build object.

In some embodiments, the application head comprises a heat application head operable to directly apply localised heat to the medium to directly bond the medium to the build object.

In some embodiments, the application head comprises a welding head operable to directly bond the medium to the build object.

Advantageously, the apparatus and method of the present disclosure provide for printing directly onto the surface of the medium. Advantageously, the apparatus and method of the disclosure provide for the directly joining or welding of the printed medium to the build object. The embodiments differ from previous approaches, in that the medium is pre-formed for application to the object. For example, the medium is not extruded, instead the medium is applied directly to the build object by bonding or joining.

In this case, the medium is preformed according to the requirements of the form of the object—as the form of the layer is not altered by extrusion. The medium is applied or joined to the object in the form that it is provided to the system.

In another embodiment, the print module further comprises an input opening for receiving a medium, and output opening through which the medium is applied to the object being made on the build platform.

In some embodiments, the medium is a preformed medium, comprising a bead or wire preformed in accordance with requirements of the object to be made.

Advantageously, the apparatus and method of the disclosure provide for the direct printing on the medium and for direct application of the medium to the object. The form of the medium is not changed or affected, for example, by extrusion.

Advantageously the apparatus of the disclosure is configured for operation with a preformed medium selected taking account of the requirements of the object being built.

In another embodiment, the print module is configured to receive the preformed medium, to directly print onto the surface of the preformed medium.

In some embodiments, the application head is configured to directly join the printed preformed medium to the object being made on the build platform. In another embodiment, the apparatus is configured to manufacture the 3D object by deposition modelling.

In some embodiments, the printhead is a colour printhead.

In some embodiments, the medium is of a plastics or polymer material.

In some embodiments, the medium comprises a plastic bead or wire.

In some embodiments, the medium comprises a plastic bead or wire preformed having diameter and form selected in accordance with requirements for the object being made.

In some embodiments, the printhead is configured to print a variable pattern onto the medium. In some such embodiments, the printhead is configured to print a variable colour pattern onto the medium.

In some embodiments, the variable pattern is variable on a pixel by pixel basis.

In some embodiments, the apparatus comprises first and second printheads configured to print the surface of the medium.

In some embodiments, at least one printhead is rotatably mounted within the print module.

In some such embodiments, the at least one printhead is mounted to rotate relative to the surface of the bead for printing the surface of the bead.

According to a further embodiment, there is provided a method for printing a 3D object:
providing 3D printing apparatus having a printing module 200 and build module 300 and controller,
providing a medium,
providing a digital print file (DPF) representative of the object to be printed including colour and form information to the 3D printing apparatus,
operating the 3D printing apparatus including the printhead to directly print a pattern onto the bead as it passes through the printing module, and
operating application head to directly join or weld the printed bead to a build object being made.

In some embodiments, the medium comprises a bead or wire preformed for application to the object, wherein the bead or wire is preformed taking account of characteristics of the object to be formed.

In some embodiments, the bead or wire is preformed for application to the object.

In some embodiments, the printhead is configured to directly print the surface of the medium as provided to the printhead.

In some embodiments, the application head is configured to directly join the printed medium as provided to the printhead to the object.

In a further embodiment, the bead is comprised of a material which provides an optically transparent layer when the layer is applied to the object.

In a further embodiment, the printhead is operable to print colour to one surface only of the material to provide a coloured layer of the object.

### BRIEF DESCRIPTION OF THE DRAWINGS

Embodiments of the disclosure will now be described with reference to the accompanying drawings in which:

FIG. 1 is a block diagram of a printing apparatus according to an embodiment of the disclosure;

FIG. 2 is a cross-sectional side view of a 3D printing apparatus according to an embodiment of the disclosure; and

FIG. 3 is a cross-sectional side view of a 3D printing apparatus according to a further embodiment of the disclosure.

### DETAILED DESCRIPTION OF THE DRAWINGS

Embodiments of the disclosure provide a 3D printing apparatus that provides full colour 3D printing.

In particular, the printing apparatus 100 relates to manufacturing the 3D object by deposition modelling.

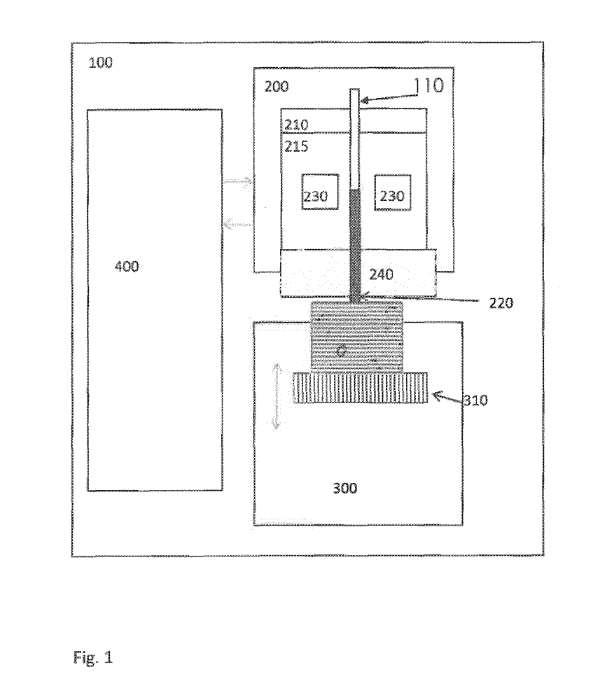

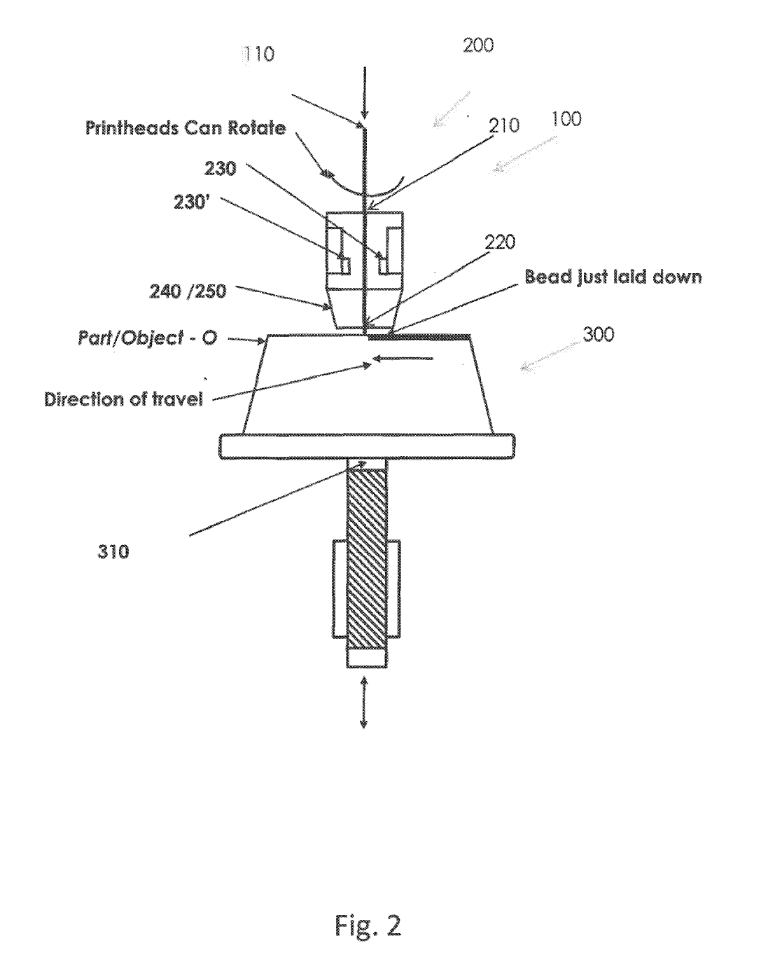

FIG. 1 is a block diagram of a 3D printing apparatus 100 according to the present disclosure. Referring to FIGS. 1 and 2, the 3D printing apparatus 100 comprises a printing module 200, and a build module 300. 3D printing apparatus 100 further comprises controller 400. The printing module 200 comprises an input opening 210 for receiving medium 110 and an output opening 220. The medium 110 may be of a plastics or polymer material. The medium 110 may be a plastic bead. The printing module 200 comprises a least one printhead 230. The at least one printhead 230 may be a colour printhead. The at least one printhead 230 is configured to print onto the medium 110 as it passes through the printing module 200. The build module 300 comprises a build plate 310 on which a build object O or part is built. The printing module 200 and build module 300 are arranged such that relative movement may be provided between the application head and build object to allow for the manufacture of an object. In an exemplary embodiment, as shown in FIG. 1, the build plate 310 is mounted to move up or down within the printing apparatus 100 relative to the printing module 200 as an object is built. The printing module 200 is mounted to move relative to the build plate 310 and the printed medium 110 is applied via the output opening 220 of the printing module 200 to the object O being built. It will be appreciated that alternative embodiments may be provided to allow the relative movement between the components, as required.

The medium 110 may comprise a bead B or wire W of a plastics or polymer material. It will be appreciated that different suitable media may be selected for building the 3D object O, based on requirements. The material, form, and dimensions of the media may be selected taking account of the properties of the object to be built. The medium is pre-formed for application to the object. This is in contrast to prior art systems which often provide for extrusion of a larger diameter bead for application to the object. In such a case the medium is not applied in its pre-formed form but rather is transformed, for example, by the extrusion process or by melting. The input and output of the print module may be adjustable to allow the feeding and handling of various forms of pre-formed media.

It will be appreciated that a bead B or wire W of different suitable form may be used. For example, in one embodiment, taking account of the application and object to be formed, a bead may be selected having diameter of the order of 0.1 mm (millimeter). For example, in another embodiment, per object requirements, a bead may be selected having a diameter of the order of 0.5 mm. It will be appreciated that the system may be used with beads or wires of different suitable diameter.

The medium 110 for printing may be provided as a bead or wire, however, it will be appreciated that alternatives may be provided.

The printing module 200 comprises an application head 240 for welding or joining or applying or bonding the medium 110 outputted therefrom to the object O being made. The application or welding provides for the joining of the bead to the object. The preformed medium is joined or bonded directly to the object. In contrast to prior art FDM approaches there is no extrusion. The form of the medium is not modified or changed.

The terms welding, bonding, joining, and applying have been used essentially interchangeably to refer to the process by which a preformed bead, having form and dimensions selected based on the particular application requirements, is joined to the object being built to manufacture the object. It will be appreciated that the joining/applying is different from extrusion processes which might involve the extrusion of a relatively larger diameter bead for the purpose of application to the object. In embodiments of the disclosure, the medium is preformed for application to the object, there is no extrusion to change the form of the medium for joining it to the object.

The application head 240 may in an exemplary embodiment be an ultrasonic transducer head. In another exemplary embodiment, the application head may be a welding head. In another exemplary embodiment, the application head may be a heating head which provides localised heating to raise the temperature of the medium at the point of application to the build object, as required, to provide a bonding or joining of the medium to the build object. In the exemplary embodiments, the medium is not extruded. The preformed medium selected for the particular object, is directly joined, or bonded or applied by the application head to the object.

The printhead 230 is configured to print onto the bead as it passes through the printing module 200. Further, the printhead 230 which in the preferred exemplary embodiment comprises a colour printhead is configured to print a variable full colour pattern on the bead as it passes through the nozzle. The printing apparatus 100 provides for the application of full colour to the bead for printing. The colour may be applied on a pixel by pixel basis. The colour printing may be done continuously. Similarly, the printed medium may be applied to the build object in a continuous method.

In the exemplary embodiment of FIG. 2 the printing module 200 comprises the application head 240, which comprises an ultrasonic transducer head 250 for welding the medium 110, for example the plastic bead, to the object O being made. In a preferred exemplary embodiment, a preformed bead or medium 110 of form and diameter selected for application to form a particular object is provided. The use of ultrasonic transducer head 250 together with the preformed bead of selected diameter in conjunction with the colour printhead 230 provides an overall advantageous embodiment for colour plastic printing of an object.

The printing apparatus 100 provides improved colour printing. Using the printing apparatus 100, a printed plastic bead may be welded or jointed to the object without affecting the colour in the way that approaches of the prior art, which included extrusion or mixing of wires of different colour, suffered problems with blending or mixing.

In the exemplary embodiment of FIG. 2, the printing module comprises two printheads 230. The printheads 230 may be located to provide for printing of substantially the surface of the bead. For example, the printheads 230 may be arranged to opposite sides of the bead. The printheads 230 may be configured to rotate so as to provide for printing of substantially the surface of the bead.

The printing module 200 comprises a chamber 215 and the plastic bead passes in through the input opening 210 through chamber 215 in proximity to the printheads 230 and towards the outlet opening 220. In the exemplary embodiment, the bead is fed in a vertical orientation through the chamber 215. It will be appreciated that various suitable embodiments of the one or more printheads 230 may be provided. Printheads 230 may include the C, Y, M and K ink printheads . The ink printheads may, for example, be arranged in a stacked configuration. As noted above, the printheads may be mounted to rotate to enable printing of the peripheral surface of the bead. The ink printheads may be mounted in a flat configuration side by side surrounding a bead passing through the chamber 215. Similarly, in this embodiment, the ink printheads may be mounted to rotate around the bead to enable printing of the peripheral surface of the bead.

It will be appreciated that suitable alternative embodiments s of a printhead according to the disclosure may be provided. For example, the printing module may include a printhead configured to rotate to provide printing of the first and second surfaces of the bead.

It will be appreciated that the printing module 200 may be mounted by any suitable means relative to the build plate 310 to enable relative movement of the printing module 200 relative to the build plate 310, as required. For example, the printing module may be mounted on an XY frame, of type known in the field of the present disclosure.

According to the disclosure there is further provided a method for colour 3D printing using the 3D printing apparatus 100.

An exemplary method according to the disclosure includes:
providing 3D printing apparatus 100 having a printing module 200 and build module 300
providing medium 110
   In a preferred exemplary embodiment, the medium comprises a bead preformed taking account of the application of the print run. It will be appreciated that the medium may be selected depending on the final object being manufactured.
operating printheads 230 to print a pattern onto the bead as it passes through the printing module 200 and
operating ultrasonic transducer head 250 to weld or join the printed bead to an object O being made.

The object is made in accordance with print files which define the colour and form of the object O to be printed.

Steps in an exemplary embodiment which will include pre-generating a digital print file are briefly noted herein, however, it will be appreciated that alternative methods may be provided. As is known in the art, 3D printing starts with a 3D data file, which is representative of the 3D object to be printed. For example the universal industry standard file format for 3D product designs, STL, as well as OBJ and VRML (for colour 3D printing) can be used with the present teaching, however, it will be appreciated that suitable alternatives may also be used. Colour is then generated and applied to the model represented in the data file. The data in such files is read and the computer model is sliced into printable layers equivalent in thickness to the media layer. Such generation of the data file usually takes place at a personal computer (PC) or computing device connected to the printing apparatus 100 however this should not be interpreted as limiting as such processing may also take place in the printing apparatus 100. It will be appreciated that in alternative embodiments the slicing could be performed in the cloud, or on a mobile device, tablet, or phone. Furthermore, the present teachings are not limited to the above method of file generation and any suitable method of generating 3D print files may be used. The pre-generated file is provided or otherwise loaded to the printing apparatus 100 prior to beginning the print job—although not shown, the printing apparatus 100 includes a processor or controller 400 and as well as memory onto which the print file is loaded.

The digital print file is again referenced or read by the controller/processor 400. The digital print file may comprise a series of images or of image pairs for each media layer. The digital print file may comprise colour image information for the first side and the second side for all portions of the medium to be applied in layers to build the object.

The 3D printing apparatus 100 is operable to print a 3D colour object. A bead or wire of a plastics or polymer material is provided to the printing module 200. The bead or wire is preformed and selected based on object requirements. For example a bead or particular diameter suitable for the object to be formed may be provided. Colour is applied as required to a bead by printing. The colour is varied as required in accordance with the features of the 3D object to be printed. The colour may be varied on a pixel by pixel basis. The printed wire is welded or joined to the object on the build plate. Controller 400 controls colour printing and welding or joining of the colour printed medium to the object.

According to a further embodiment of the disclosure, a system and method for manufacture of a colour plastic object is provided for application with a transparent bead (or medium) 540 or wire of a plastics material. The transparent bead 540 can be used to build an object O. In the method, a transparent bead 540 is provided to the printing module, to manufacture a full colour object, it is not necessary to apply colour to all sides of the transparent bead 540. According to a preferred method colour is applied to one surface or side wall only of the bead. Colour may be applied to one surface of the bead as the bead is fed through the application head 240 for application to the object. Similar to the method as described above, the colour is applied to the transparent bead 540 before it is welded to the object O. In accordance with the digital print file and image pairs, the colour is varied continuously throughout the method. The colour of the object O is achieved by virtue of the interaction and synergy between the transparent bead 540 used to form a layer of the object O and the colour applied to one or more surfaces of the layer of the object O. The optical properties of the transparent bead 540 are such that after the bead is laid down, the layer has a colour appearance.

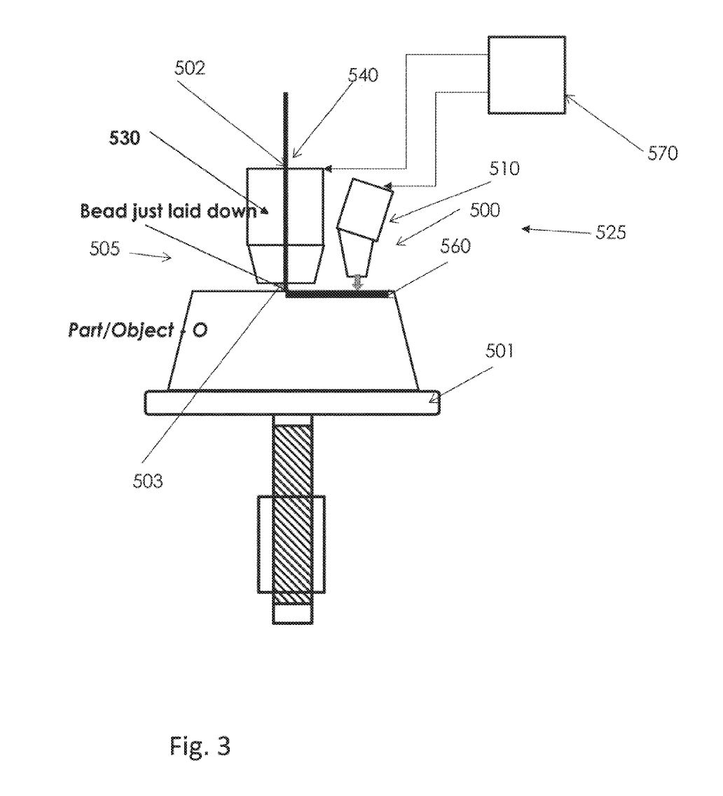

Referring to FIG. 3 a further system and method according to the disclosure are provided. The system 500 of FIG. 3 is similar to the printing apparatus 100 of FIGS. 1 and 2. The system 500 comprises a build plate 501. The system 500 comprises an application head 530 for applying the bead to the build object O. Successive layers of the object O are laid down on the build plate 501 and successive layers of the build object (O) to form the object.

The system 500 may include one or more application heads 530. The application heads 530 may be configured to be selected or used interchangeably to build the object O. Suitable application head 530 types include: one or more extrusion heads, an ultrasonic head, and a welding head.

Different extrusion heads for use with system 500 may be provided. Different extrusion heads may have different operation temperatures or be configured for use with different forms or types of bead or input material. One of the alternative application heads 530 may be selected for use to lay down an object layer 560 having a particular predefined form.

In the case that an ultrasonic head or a welding head is used, the features of the ultrasonic head or welding head and operation thereof include those as described above with reference to FIGS. 1 and 2.

The system 500 further comprises a printhead 510. The printhead 510 is arranged to apply colour to the object layer 560 when the object layer 560 is applied to the object O by application head 530. Effectively, colour is applied to a surface of the uppermost object layer 560 in series with the application of the bead on the build object O resulting in the forming of colour layers. The full colour layers are formed on a layer by layer basis.

The printhead is located near the application head. In the embodiment shown, the printhead is downstream from the application head. The distance between the printhead and application head may be varied or set as required.

The application of the medium (or transparent bead) 540 to the object O to form object layer 560 and the application of colour to the object layer 560 using printhead 510 is done in a continuous process. The application of the transparent bead 540 to form the layer and colour is done in a serial process. The digital print file via controller 570 provides control instructions to the 3-D printer—to application head 530 as to the form of the object layer 560 at a particular point. The digital print file provides control instructions to the printhead 510 as to the colour of the object layer 560 at a particular point. The colour applied to the object layer 560 can be controlled from pixel to pixel depending on requirement.

The system 500 provides in particular for the application a transparent bead 540 to form a transparent plastic object layer 560. The transparent bead 540 provided to the system has optical properties to produce the colour object O as required.

A transparent bead 540 having required optical properties is provided to the system. It will be appreciated also that for the manufacture of an object by the system 500, an application head 530 is provided. The application head 530, such as one of the possible extrusion heads, may be selected for use in manufacturing the object O, dependent on appropriateness to control or modify the properties of the transparent bead 540 to manufacture the object layer 560. For example, different operating temperatures may be required in the steps of application or extrusion of the transparent bead 540 to produce a portion of object layer 560 having particular optical properties. For example, in a further embodiment, the thickness and form of the object layer 560 may be varied or controlled by selection and control of operation of the application head 530. The method provides manufacture of a colour object by virtue of the interaction of the colour applied to one surface of the object layer 560 and the transparent properties of the material of the object layer 560.

Using the system 500 or the method to manufacture a full colour object, it is not necessary to apply colour to all sides of the transparent bead 540. According to a preferred method, colour is applied to one surface or side wall only of the bead. Colour may be applied to one surface of the transparent bead 540 as the object layer 560 is formed by application of the transparent bead 540 to the object O. Colour is applied to the object layer 560 that has been joined or welded to the object O. In accordance with the digital print file and image pairs, the colour is varied continuously throughout the method. The colour of the object is achieved by virtue of the interaction and synergy between the layer of the object which has properties of transparency and the colour applied to one surface of the layer of the object. The layers are 2 dimensional layers having upper, lower, and side surfaces. The optical properties of the transparent bead are such that after the bead is laid down, and colour applied, then the layer has a colour appearance. The use of the transparent layer together with application of colour to one surface allows for a reduction in the colour printing requirements.

The embodiment shown in FIG. 3, like the other embodiments, addresses issues of the prior art and a demand for the provision of an apparatus and method for the manufacture of a 3-D colour object having full colour properties.

A final colour effect of the object may be achieved by a judicious selection of the transparent bead, by the application which may possibly include modification of properties or form of the bead, and by application of colour to one surface only of the bead.

The method of manufacturing a 3D object using the system 500 provides for building the object layer 560 by layer and includes the following:
Providing a transparent bead 540 to provide a layer having the required optical properties
Selecting an application head 530
Providing a digital print file to controller 570
Forming an object layer 560 according to the digital print file
Printing one surface of the object layer 560 and wherein the colour may be varied as required according to the digital print file from pixel to pixel.

The system 500 comprises controller 570, a build platform 501, application head 530 and printhead 510. Transparent bead 540 is provided as input. The bead of the present exemplary method is a transparent bead 540. As noted above the transparent bead 540 is selected in part for the optical properties of the bead and further taking account of the optical properties of the layer when the bead is formed into the object layer 560. The system 500 provides for the use of one or more different application heads 530—including extrusion heads, welding heads, and ultrasonic heads—to produce the form of layer required, and a layer having the required optical properties. An application head 530 may be selected and installed to manufacture a particular 3D object.

It is noted that it is the combination of the transparency properties of the layer or appearance of a point of the layer of the object and the colour applied to the surface of the layer at the particular point, which provide the finished colour object when viewed together.

The system 500 and the method described above provide for the manufacture of a full colour plastics object with high levels of control of the colour of the object. Colour can be controlled from layer to layer and point to point.

The object is made in accordance with print files which define the colour and form of the object to be printed.

The bead may be transparent bead (or medium) 540 or wire of a plastics material. The transparent bead 540 can be used to build an object O. In the method, a transparent bead 540 is provided to the printing module. To manufacture a full colour object, it is not necessary to apply colour to all sides of the transparent layer.

Steps in an exemplary embodiment which will include pre-generating a digital print file are noted herein, however, it will be appreciated that alternative methods may be provided. As is known in the art, 3D printing starts with a 3D data file, which is representative of the 3D object to be printed. For example, the universal industry standard file format for 3D product designs, STL, as well as OBJ and VRML (for colour 3D printing) can be used with the present teaching, however, it will be appreciated that suitable alternatives may also be used. Colour is then generated and applied to the model represented in the data file. The data in such files is read and the computer model is sliced into printable layers equivalent in thickness to the media layer. Such generation of the data file usually takes place at a PC or computing device connected to the system 500, however, this should not be interpreted as limiting as such processing may also take place in the system 500. It will be appreciated that, in alternative embodiments, the slicing could be performed in the cloud, or on a mobile device, tablet, or phone. Furthermore, the present teachings are not limited to the above method of file generation and any suitable method of generating 3D print files may be used. The pre-generated file is provided or otherwise loaded to the system 500 prior to beginning the print job—although not shown, the system 500 includes a processor or controller 570, as well as memory onto which the print file is loaded. The digital print file is again referenced or read by the controller/processor 570. The digital print file may comprise a series of images for each object layer 560 of the object to be built. The digital print file may comprise colour image information for each layer.

The system 500 is operable to print a 3D colour object. A bead or wire of a plastics or polymer material is provided to the printing module. Colour is applied directly to the formed object layer. In a preferred embodiment, colour is applied to one surface of the layer. The colour is varied as required in accordance with the features of the 3D object to be printed. The colour may be varied on a pixel by pixel basis. The printed wire is welded or joined to the object on the build plate. Controller 570 controls colour printing. Controller 570 also controls the formation of the object layer 560 and its addition to the build object by welding or joining of the medium 540 to the object O. Once the layer is formed it is then printed.

It is clear that the system 500 and method described provides the required colour finish based on printing of colour on one side of a layer, the layer having optically transparent properties.

As discussed in the background there are issues associated with the use of FDM machines for colour. In the prior art, attempts have been made to combine various colours of plastic beads to get a blended colour, however this colour can't change pixel per pixel. Often blending issues may occur. Such a prior art system simply would not provide the control and colour quality provided by embodiments of the present disclosure.

Accordingly, embodiments of the disclosure in which a preformed bead is used provide a number of advantages in comparison with approaches of the prior art including: provides a head to weld the plastic bead to the part being made; provides printing variable full colour pattern onto the bead as it passes through the nozzle; provides for use of reduced diameter size of bead for example reduced to 0.1 mm diameter, this reduces the need for extrusion; and provides a full colour plastic 3D printer of high quality colour.

Advantageously, the apparatus and method of FIGS. 1 and 2 of the present disclosure provide for the printing of colour directly onto the surface of the medium and then for the joining or welding of the bead directly to the object. The medium is preformed taking account of requirements of the object. Advantageously, the apparatus and method provide for the direct printing and welding or joining of the printed medium, for example without the need for extrusion. The apparatus and method provide a direct deposition modelling.

The apparatus and method provide manufacture in a method somewhat similar to FDM, however, as described and discussed above the medium is not extruded prior to joining, welding, or bonding to the object for object manufacture.

The apparatus and methods, including use of a transparent bead, provide for manufacture of a colour object and provide an excellent colour finish by application of colour to one surface only of the bead or the freshly formed layer.

The apparatus of FIG. 3 advantageously achieves a high quality true colour finish. The apparatus further provides excellent flexibility in the selection of an application head and method for forming the object. Effectively different processes may be used to form a colour object using the same 3-D printing apparatus and colour print-head.

The words comprises/comprising when used in this specification are to specify the presence of stated features, integers, steps or components but does not preclude the presence or addition of one or more other features, integers, steps, components, or groups thereof.

1. An apparatus for 3-dimensional (3-D) printing an object, the apparatus comprising:
a build module, having a build platform
a print module, comprising:
an application head configured to form an object layer from a medium; and
a printhead, located in series with the application head and configured to apply a colour to the object layer;
wherein the object layer is optically transparent; and
the printhead is configured to apply the colour to one surface of the object layer to produce a layer of a required colour finish.

2. The apparatus of claim 1, wherein the apparatus is configured to interchangeably receive the application head.

3. The apparatus of claim 1, wherein the application head is configured to directly join the medium to a build object on the build platform to form the object layer.

4. The apparatus of claim 1, wherein the application head comprises one of an extrusion head, a welding head, or an ultrasonic head.

5. The apparatus of claim 1, wherein the print module further comprises an input opening for receiving the medium, and an output opening through which the medium is applied to an object being made on the build platform.

6. The apparatus of claim 1 wherein the object layer as formed by the application head is optically transparent.

7. The apparatus of claim 1 further comprising a controller configured to receive a digital print file for an object, and to control the application head and printhead according to the digital print file to form and apply colour to layers of the object.

8. The apparatus of claim 7, wherein the digital print file includes information relating to the forms and colours of the layers of the object.

9. The apparatus of claim 7, wherein the printhead is configured to vary the colour applied to the object layer according to the digital print file, wherein the colour may be varied from pixel to pixel of the object layer.

10. The apparatus of claim 1 wherein the printhead is configured to apply the colour to one surface of the object layer.

11. The apparatus of claim 1, wherein the apparatus is configured to 3-D print an object by deposition modelling in which the medium is applied directly to the object.

12. The apparatus of claim 1, wherein the printhead is a colour printhead.

13. The apparatus of claim 1, wherein the medium comprises a plastics or polymer material.

14. The apparatus of claim 1, wherein the medium comprises a plastic bead or wire.

15. The apparatus of claim 1, wherein the printhead is configured to print a variable pattern onto the object layer.

16. The apparatus of claim 1, wherein the printhead is configured to print a variable colour pattern onto the layer.

17. The apparatus of claim 16, wherein the the printhead is configured to vary the variable colour pattern on a pixel by pixel basis.

18. A method of manufacturing a colour 3-dimensional (3D) object including applying a medium to a build object layer by layer including:
receiving a bead or material for application to a build object to form a layer of the build object;
selecting an application head;
receiving a digital print file;
forming an object layer of the build object, the layer having a form according to the digital print file;
printing a surface of the object layer, wherein a colour applied to the object layer is varied according to the digital print file on a pixel by pixel basis.

19. The method of claim 18 wherein the bead or material comprises a transparent material which is rendered optically transparent upon application to the build object to form the object layer.

20. The method of claim 18, wherein the build object comprises a plurality of object layers, and the method further comprises forming each object layer and printing each object layer in a single continuous process.

21. The method of claim 18, further comprising determining final optical properties of the object layer by selecting the bead or material and selecting the application head.

22. The method of claim 18, wherein the application head is configured to control an optical property or transparency of the object layer.

23. The method of claim 18, wherein the application head is configured to control an optical property of the object layer by one of application, pressure, or temperature.

24. The method of claim 18, further comprising applying the colour to the freshly formed transparent object layer in accordance with the digital print file.

25. The method of claim 18, wherein the bead or material comprises a material which provides an optically transparent object layer when the bead or material is applied to the build object.

26. The method of claim 18, comprising printing only one surface of the bead or material.
